(19) United States
(12) Patent Application Publication
(10) Pub. No.: US 2024/0401741 A1
(43) Pub. Date: Dec. 5, 2024

(54) MOBILE LNG STORAGE AND REGASIFICATION UNIT (MSRU)

(71) Applicant: CryoPort E&O LLC, Dallas, TX (US)

(72) Inventor: Kishore Duwadi, Dallas, TX (US)

(21) Appl. No.: 18/734,355

(22) Filed: Jun. 5, 2024

Related U.S. Application Data
(60) Provisional application No. 63/471,057, filed on Jun. 5, 2023.

(51) Int. Cl. F17C 1/00

(52) U.S. Cl. CPC F17C 1/00; F17C 2205/0107; F17C 2205/0134; F17C 2221/033; F17C 2227/0135; F17C 2227/0304; F17C 2250/032; F17C 2265/05

(57) ABSTRACT

A mobile storage and regasification unit (MSRU) is a liquefied natural gas (LNG) storage and regasification platform (apparatus/vessel) designed to provide natural gas as fuel for power generation and heating applications that have limited or no access to grid-supplied power or natural gas pipelines.

### CROSS-REFERENCE TO RELATED APPLICATIONS

This application claims priority to, and the benefit of, U.S. Provisional Patent Application Ser. No. 63/471,057 filed Jun. 5, 2023, and entitled “Mobile LNG Storage And Regasification Unit (MSRU),” the disclosure of which is incorporated herein by reference in its entirety.

### TECHNICAL FIELD

The present disclosure relates to a mobile liquefied national gas (“LNG”) storage and regasification unit (“MSRU”) in which all components are architecturally assembled into a singled fueling platform. The MSRU is designed to provide natural gas as fuel for power generation and heating applications in remote operations that have limited or no access to grid-supplied power or natural gas pipelines.

### SUMMARY

An MSRU of the present disclosure includes one or more LNG storage tanks and a Secondary Containment Unit that houses regasification equipment. The LNG storage tank(s) may be elevated above and/or positioned on top of the Secondary Containment Unit.

The details of one or more implementations of the systems and methods of the present disclosure are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 is a perspective side view of an implementation of an MSRU with a standard configuration, according to the present disclosure.

FIG. 2A depicts another implementation of an MSRU with a standard configuration, shown in perspective side view in two different positions.

FIG. 2B depicts the MSRU of FIG. 2A without the shipping container to display the regasification equipment, the connecting lines to the LNG storage tank, and the inlet lines to which a fueling truck connects.

FIG. 2C depicts the MSRU of FIG. 2A with part of the shipping container removed to display the regasification equipment, the connecting lines to the LNG storage tank, and the inlet lines to which a fueling truck connects.

FIG. 3 is a perspective side view of an implementation of an MSRU with a high volume, high pressure configuration, according to the present disclosure.

FIG. 4 is a perspective side view of a representative operational environment with several MSRU of the standard configuration shown in a side-by-side arrangement next to a fueling truck.

FIG. 5 is a perspective side view of a representative operational environment with several MSRU of the high pressure/high volume configuration shown in a side-by-side arrangement next to a fueling truck and operatively coupled to a mobile frac pump system.

FIG. 6A is a portion of a representative piping and instrumentation diagram of an implementation of an MSRU according to the present disclosure.

FIG. 6B is a representative full piping and instrumentation diagram of an implementation of an MSRU according to the present disclosure.

FIG. 7 through FIG. 11 are representative computer screen shots from the display of an operator interface with an MSRU according to the present disclosure.

Like reference symbols in the various drawings indicate like elements.

### DETAILED DESCRIPTION

The present disclosure relates to a mobile liquefied national gas (“LNG”) storage and regasification unit (“MSRU”) in which all components are architecturally assembled into a singled fueling platform designed to provide natural gas as fuel for power generation and heating applications such as, among others, power generators, asphalt plants, industrial drying operations, etc. in remote operations that have limited or no access to grid-supplied power or natural gas pipelines.

### Major Components:

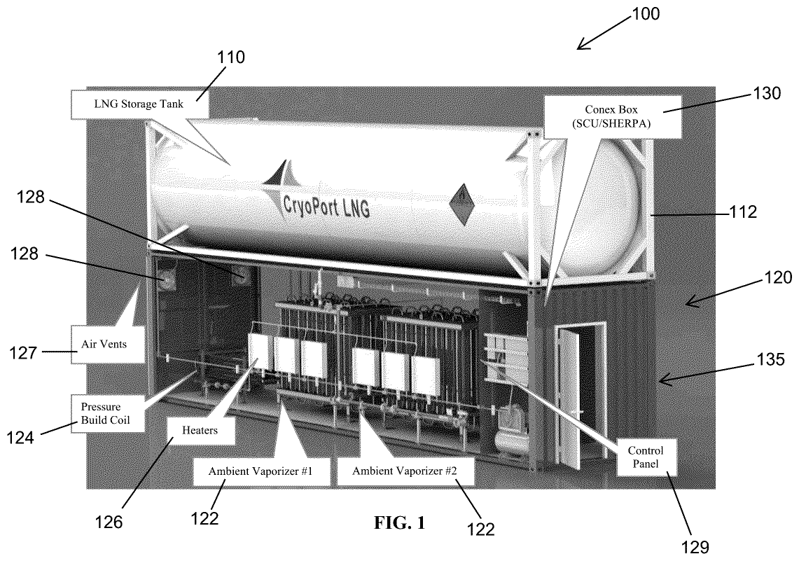

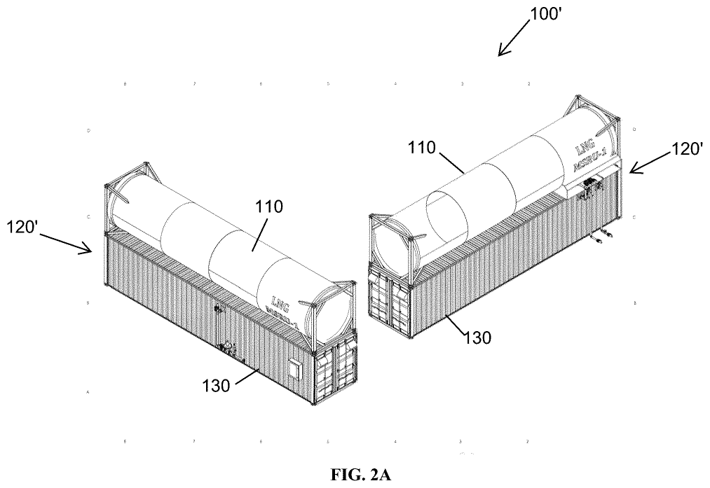

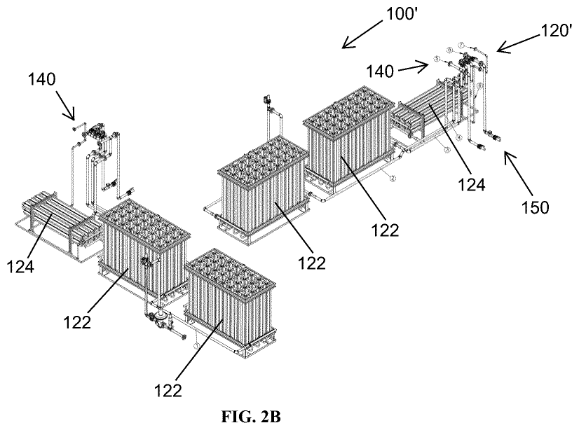

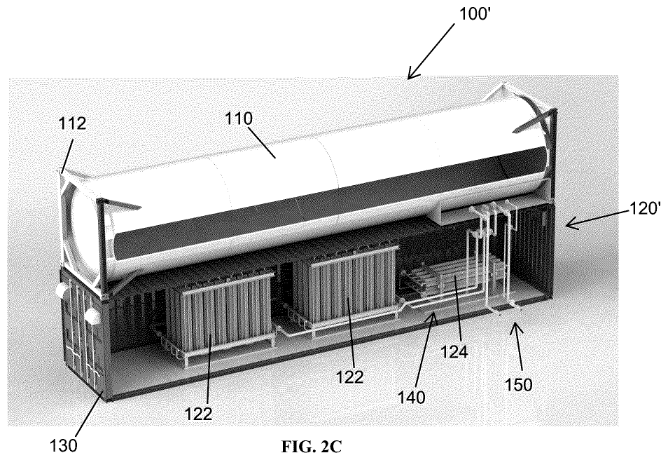

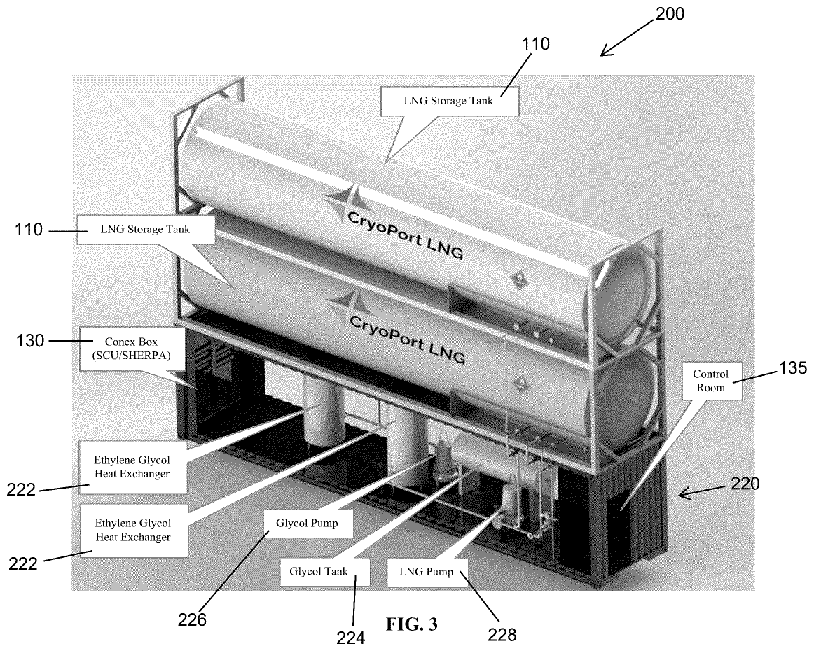

Referring to FIG. 1., FIG. 2A-2C, and FIG. 3, an MSRU 100, 100′, 200 is comprised of: (1) one or more LNG storage tanks 110, and (2) a Secondary Containment Unit (the “SCU”, which may be referred to herein using its brand name as the SHERPA™ unit) 120.

The LNG storage tank 110 may be a standard 10,000-gallon cryogenic ISO container (the “ISO”) which sits in a metal frame 112 that allows the ISO container to be placed on any flat surface, such as the roof of a shipping container.

The SHERPA™ unit 120 comprises regasification equipment that may include two ambient vaporizers 122, a pressure build coil (BPC) 124 or an LNG pump 228, a supplemental heating system of radiant heaters 126, one or more forced air fans 128, along with valves, pipes, and control and monitoring equipment, which may include a control panel 129, and in some implementations, the control panel 129 is housed within a control room 135. The SHERPA™ unit 120 is fitted inside a shipping container (Conex Box) 130, which can be a standard size (40 ft. long) and either 8 ft. height or high capacity (HC) with 10 ft. height.

The MSRU 100, 100′, 200 of the present disclosure includes an elevated LNG storage tank 110 placed on top of the SHERPA™ unit 120. This placement results in higher differential pressure and net positive suction head (NPSH) to LNG pumps 228, if used, or gravity flow to the pressure build coil 124. The LNG pumps 228 or the pressure build coil 124 are used to provide required gas pressure and flow to the customer equipment. The shipping container 110 of the SHERPA™ unit 120 also serves as a secondary LNG spill containment as required by national LNG codes and regulation. The entire MSRU 100, 100′, 200 can be placed on a hard level surface eliminating the foundation requirements that are needed for existing traditional fueling applications.

### Standard Configuration:

Referring now to FIG. 1, which depicts one implementation of a MSRU 100 in a standard configuration where the ISO tank 110 is placed on top of the SHERPA™ unit 120 and the two are connected using specially designed pipes and valves. As previously mentioned, the SHERPA™ unit 120 may comprise a modified HC Conex Box 130 with various mechanical/manufacturing adjustments to ensure adequate air flow, generate supplemental heat for regasification of LNG in colder ambient temperatures, and create additional pressure to facilitate loading and offloading of LNG into and out of the ISO storage container. The SHERPA™ unit 120 may also comprise two vaporizer units 122 that convert LNG into natural gas before evacuating it to the consuming application, such as a generator.

In some implementations, the standard configuration MSRU 100 is designed to generate approximately 10,000 standard cubic feet per hour (scf/hr) of natural gas floor at up to 45 pounds per square inch (psi) of pressure.

FIG. 2A depicts another implementation of a MSRU 100′ with a standard configuration, shown in perspective side view in two different positions.

FIG. 2B depicts the SHERPA™ unit 120′ of the MSRU 100′ of FIG. 2A without the shipping container 130 to display the regasification equipment, the connecting lines 140 to the LNG storage tank, and the inlet lines 150 to which a fueling truck connects. The regasification equipment comprises a pressure build coil 124 and two vaporizers 122, but the MSRU of FIG. 2A does not include heaters 126 like the MSRU 100 of FIG. 1.

FIG. 2C depicts the MSRU 100′ of FIG. 2A, showing the SHERPA™ unit 120′ with part of the shipping container 130 removed to display the regasification equipment, including the vaporizers 122 and the pressure build coil 124, the connecting lines 140 between the LNG storage tank and the regasification equipment, and the inlet lines 150 to which a fueling truck connects to fill the LNG storage tank.

### High Volume/High Pressure (HV/HP) Configuration:

Referring now to FIG. 3, which depicts one implementation of a MSRU 200 in a HV/HP configuration, two ISO tanks 110 are stacked on top each other and are placed on the SHERPA™ unit 220. In MSRU 200, as compared to the MSRUs 100, 100′ of FIG. 1 and FIGS. 2A-2C, the ambient vaporizers 122 are replaced by two ethylene glycol heat exchangers 222, the heaters 126 and the pressure build coil 124 are removed, and a glycol tank 224, a glycol pump 226, and an LNG pump 228 are added.

The HV/HP MSRU 200 is operable to serve high volume/high pressure requiring applications, such as frac pumps and drilling rigs. The HV/HP MSRU 200 may be capable of generating 250,000 scf/hr of flow at a sustained pressure of 150 psi.

Regardless of the configuration, an MSRU 100, 100′, 200 is a fully automated, remotely monitored, completely mobile and self-contained storage and regasification unit, which can easily be deployed to customers' sites quickly and cost-effectively. Due to its stacked configuration, an MSRU 100, 100′, 200 minimizes site preparation costs and significantly reduces time to operation. Upon the completion of each project, an MSRU 100, 100′, 200 can be redeployed to a new site without any new capital expenditures, thus significantly improving the return profile of each project.

### Operational Environments:

The MSRU 100, 100′, 200 of the present disclosure can be used to provide fueling solutions in many different operational environments, industries and market segments.

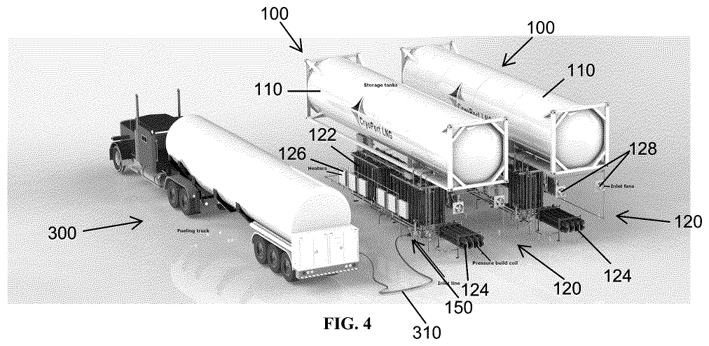

FIG. 4 is a perspective side view of one representative operational environment in which two MSRU 100 of the standard configuration are positioned side-by-side next to a fueling truck, also referred to as a tanker trailer 300. In FIG. 4, the SHERPA™ units 120 of the two MSRU 100 are shown without the shipping containers 130 to display the regasification equipment, including the vaporizers 122, the pressure build coils 124, and the heaters 126.

Still referring to FIG. 4, LNG is transported to the MSRU 100 by a tanker trailer 300. A supply hose 310 is connected between the tanker trailer 300 and the MSRU fill line 150. A pressure transfer method is used to transfer the LNG from the higher-pressure tanker trailer 300 to the lower pressure MSRU storage, i.e., the LNG storage tank 110 in the ISO container 130. The double insulated vacuum jacketed LNG storage tank 110 can safely hold the liquid for months without excessive pressure buildup. If the pressure inside the LNG storage tank 110 reaches beyond the tank design pressure, the tank pressure relief valves open and vent the pressure to a safe point.

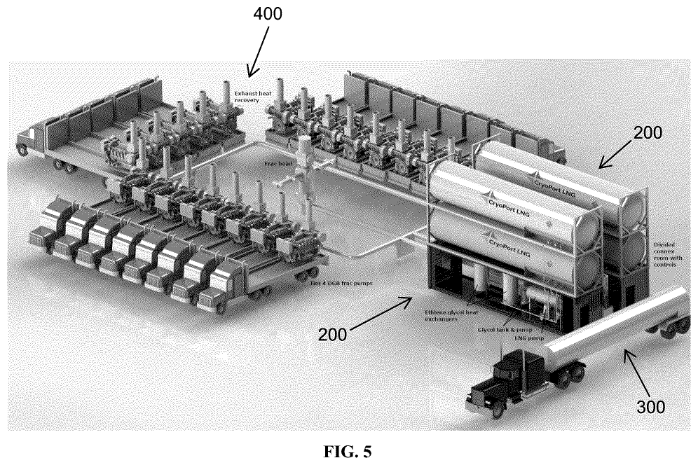

FIG. 5 is a perspective side view of another representative operational environment in which two HP/HV MSRU 200 are positioned side-by-side next to a tanker trailer 300 and operatively connected to provide fuel to a mobile frac pump system 400. In FIG. 5, the SHERPA™ units 220 of the two MSRU 200 are shown with a portion of the shipping container 130 removed to display the internal equipment.

An MSRU 100, 100′, 200 can be used to provide cost effective and functionally robust fueling solutions to at least the following representative industries and market segments:
Asphalt paving
Distributed power generation
Grid resiliency/peak shaving
Complementary energy provisioning for intermittent renewable energy sources
Pipeline outage and repair projects
E&P applications (frac spreads and drilling rigs)
Mining extraction and transportation equipment
Maritime sustainability/LNG bunkering
Brown water barge operations
Railroad/locomotive applications
Commercial and industrial applications (boilers, furnaces, dryers, etc.)
Agricultural applications (US and Northern Mexico)
Food processing facilities (US and Northern Mexico)
Beverage bottling plants
Poultry farms
Large hotel/casino HVAC and swimming pool heating
Off-grid electric generation for large truck charging stations
Bitcoin mining operations

### Operational Summary:

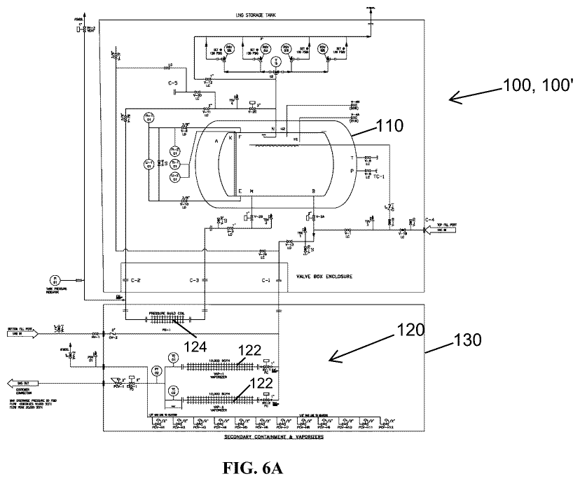

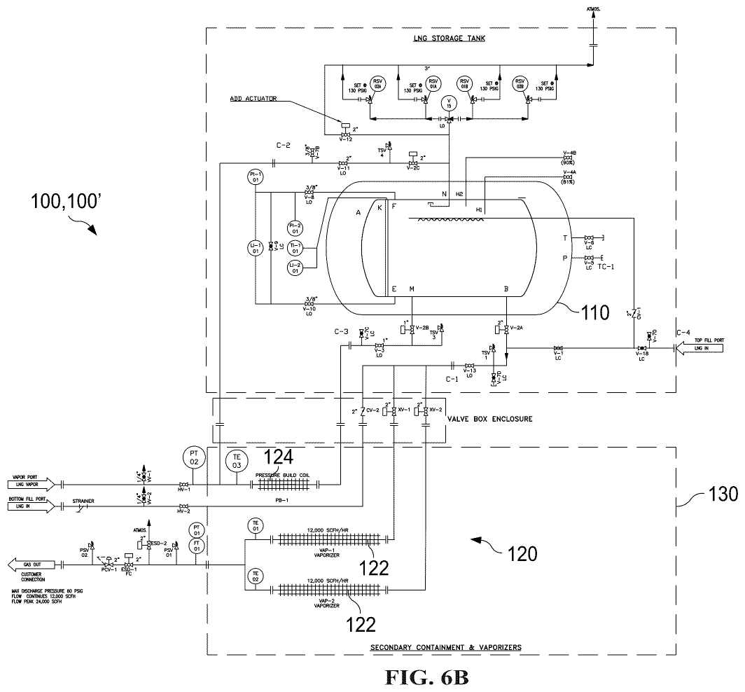

FIG. 6A is a portion of a representative piping and instrumentation diagram (“P&ID”) of a MSRU 100, 100′ of the standard configuration according to the present disclosure. FIG. 6B is a representative full P&ID of a MSRU 100, 100′ of the standard configuration according to the present disclosure. FIG. 6B includes a legend listing the tag number and description for each component shown in the P&ID, as well as representative nominal sizes for each component. The tag number of the components are referred to in the following operational descriptions.

### LNG Storage Tank Pressure Control:

The pressure of the LNG storage tank 110 is maintained as required by the customer using the pressure build coil 124 and an automatic vent valve “VV2”. If the pressure of the LNG storage tank 110 drops below the required pressure setpoint, LNG flows from port “M” through valve “V-2B” to the pressure build coil 124. Ambient heat vaporizes the LNG, and it is diverted to the top of the LNG storage tank 110 via valve “V-2C”. If the pressure of the LNG storage tank 110 rises above the required pressure setpoint, valve V2-B closes and vent valve VV2 opens. The gas is vented to a safe location and the tank pressure is reduced.

### Vaporization Control:

Within the SHERPA™ unit 120, 120′ there are two ambient vaporizers 122 to vaporize the LNG. Only one vaporizer 122 is active at a time. Automatically operated valve “XV-1” supplies gas to the first vaporizer 122 and valve “XV-2” supplies LNG to the second vaporizer 122. As the gas demand increases, the pressure regulator valve “PCV-1” opens and pressure inside the vaporizers 122 drop. LNG flows from port “B” of the LNG storage tank 110 via automatic valve “V-2A” to the operative first or second vaporizer 122. The control system opens either valve “XV-1” or valve “XV-2” depending on the gas outlet temperature monitored by temperature element “TE-1” or “TE-2”. Ambient temperature vaporizes the LNG and gas is discharged via emergency shutdown valve “ESD-1”. As the outlet gas temperature drops due to icing of the operative first or second vaporizer 122, the control system automatically closes valve XV-1 and opens valve XV-2, or vice versa, to supply LNG to the other vaporizer 122.

### Safety Systems:

There are four automatic emergency shutdown valves. Valves V-2A, V-2B, V-2C isolate the LNG tanks 110 from the vaporizers 122. Valve ESD-1 closes the discharge line to the vaporizers 122 and stops gas flow to the customer. The emergency shutdown valves are controlled by a hard-wired relay logic and can be activated by pushing the emergency shutdown switch. In addition to the manually operated ESD switch, lower explosive limit (“LEL”) gas detectors close all the automatic valves if the gas level inside the SHERPA™ unit 120, 120′ exceeds the 25% lower flammability level. Pressure relief valves are also provided to ensure the system pressure is kept under the design pressure.

### Forced Air System:

To maintain a lower moisture level within the SHERPA™ unit 120, 120′, two forced air fans 128 disposed in air vents 127 formed in the shipping container, as best shown in FIG. 1, are used to move the air inside the shipping container 130.

### Radiant Heater System:

During unusually cold days, gas fired radiant heaters 126, as best shown in FIG. 1, are used to control the moisture level inside the SHERPA™ unit 120. These heaters 126 are automatically turned on during cold weather.

### Operator Interface

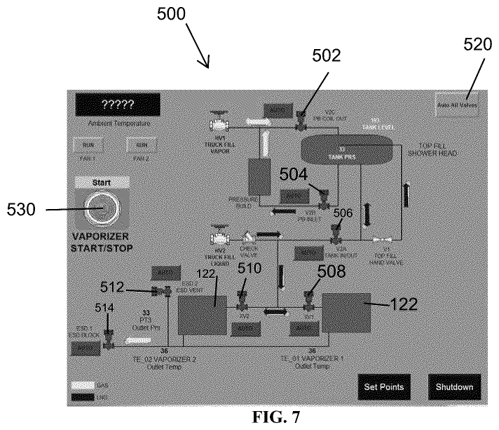

As depicted in FIG. 1 and FIG. 3, the various implementations of MSRU of the present disclosure may include a control room 135 that houses a computer equipment operated by software to enable full automation and remote monitoring of MSRU operations. In some implementations, the computer equipment includes a control panel 129 comprising an operator interface with a display presenting schematic representations of the MSRU equipment and information about the operational status of that equipment. FIG. 7 through FIG. 11 show representative computer screen shots from an operator interface display 500 according to the present disclosure.

FIG. 7 depicts a representative screen shot of an operator interface display 500 when the vaporizers 122 of the MSRU 100, 100′ have stopped. In this operational condition, all automatic valves 502, 504, 506, 508, 510, 512, 514 of the MSRU 100, 100′ are also closed. To open any of the automatic valves 502, 504, 506, 508, 510, 512, 514, the operator presses the corresponding “AUTO” push button shown next to each valve on the operator interface display 500. To put all of the automatic valves 502, 504, 506, 508, 510, 512, 514 in the auto position, the operator presses the rectangular “Auto All Valves” button 520 shown in the upper right hand corner of the display screen 500 of FIG. 7. To start the vaporizer 122, the operator presses the start button 530 labeled as “VAPORIZER START/STOP” in the middle left side of the operator interface display 500.

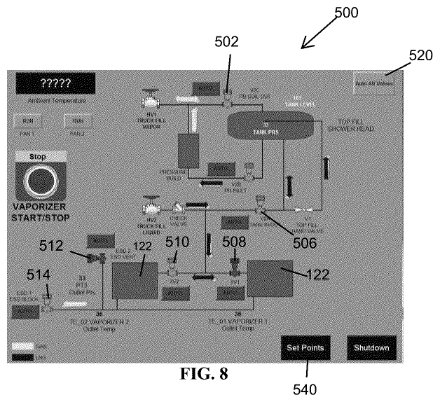

FIG. 8 depicts a representative screen shot of an operator interface display 500 when the second vaporizer 122 (Vaporizer 2) is running. In this operational condition, automatic valves 502, 504, 506, 510 and 514 are open, including valve 504 (the pressure build coil liquid valve V2B) and valve 502 (the pressure build coil outlet valve V2C), which are open to build tank pressure. The tank pressure setpoint can be changed on the Set Points screen, which requires the operator to press the rectangular “Set Points” button 540 shown toward the bottom right of the operator interface display 500. Valve 506 (tank outlet valve V2A) is open to supply LNG to the vaporizers 122, and valve 510 (Vaporizer 2 inlet valve XV2) is also open. Valve 514 (customer supply valve ESD 1) is open, while valve 512 (MSRU vent valve ESD 2) is closed.

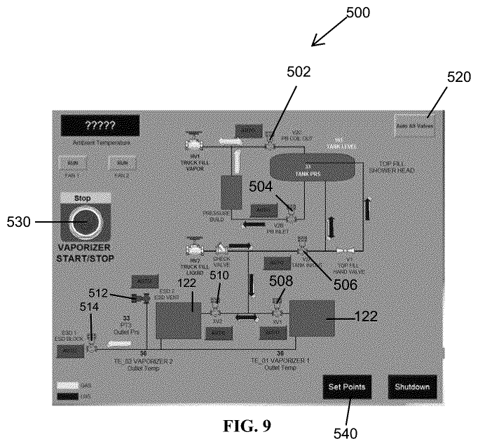

FIG. 9 depicts a representative screen shot of an operator interface display 500 when the first and second vaporizers 122 are switching, which occurs when the vaporizer discharge temperature falls below the setpoint, such as −20 to 250 degrees fahrenheit, for example. In some implementations, the temperature dead band is 5 degrees fahrenheit, and valve 508 (labeled XV1) and valve 510 (labeled XV2) supplying LNG to both vaporizers 122 (Vaporizer 1 and Vaporizer 2) will stay open for a set period of time, such as 30 seconds, for example. Then the LNG supply to the last operational Vaporizer (in this case Vaporizer 2) will stop by closing valve 510 (labeled XV2).

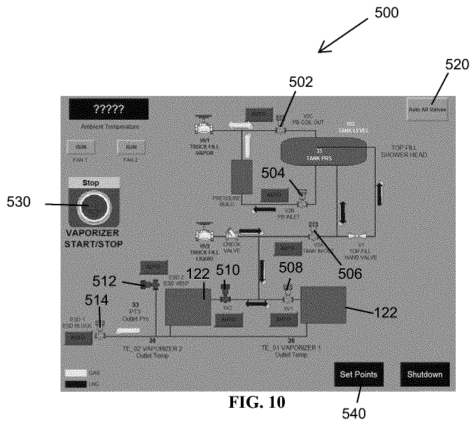

FIG. 10 depicts a representative screen shot of an operator interface display 500 when Vaporizer 1 is running. In this operational configuration, valves 502, 504, 506, 508 and 514 are open, including valve 504 (the pressure build coil liquid valve V2B) and valve 502 (the pressure build coil outlet valve V2C), which are open to build tank pressure. The tank pressure setpoint can be changed on the Set Points screen, which requires the operator to press the rectangular “Set Points” button 540 shown toward the bottom right of the display screen 500. Valve 506 (tank outlet valve V2A) is open to supply LNG to the vaporizers 122, and valve 508 (Vaporizer 1 inlet valve XV1) is also open. Valve 514 (customer supply valve ESD 1) is open, while valve 512 (MSRU vent valve ESD 2) is closed.

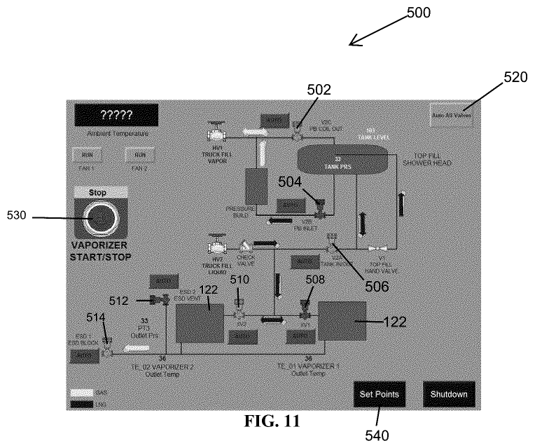

FIG. 11 depicts a representative screen shot of an operator interface display 500 when the LNG storage tank pressure is high. When tank pressure exceeds the set point, which may be set from 2 to 60 pounds per square inch gauge (“psig”), for example, valve 504 (the pressure build coil liquid valve V2B) will close to stop the tank pressure buildup. Valve 502 (the pressure build coil outlet valve V2C) remains open, but only operates during tanker truck transfer, if needed.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A mobile liquefied national gas (“LNG”) regasification and storage unit (“MSRU”) comprising:
a LNG storage tank; and
a secondary containment unit housing regasification equipment operatively coupled to the LNG storage tank;
wherein the LNG storage tank is elevated above and supported by the secondary containment unit.

2. The MSRU of claim 1, wherein the secondary containment unit comprises an inlet line operatively coupled to the LNG storage tank for delivery of LNG by a tanker truck.

3. The MSRU of claim 1, wherein the secondary containment unit comprises a control room housing computer equipment to control the operation of the MSRU.

4. The MSRU of claim 3, wherein the computer equipment comprises an operator interface with a display.

5. The MSRU of claim 1, wherein the regasification equipment comprises:
at least one vaporizer; and
a pressure build pump operatively coupled to the at least one vaporizer.

6. The MSRU of claim 5, wherein the regasification equipment further comprises:
a system of radiant heaters.

7. The MSRU of claim 1, wherein the secondary containment unit comprises an air vent.

8. The MSRU of claim 7, further comprising:
a forced air fan disposed in the air vent.

9. The MSRU of claim 1, further comprising:
a second LNG storage tank elevated above and operatively coupled to the LNG storage tank.

10. The MSRU of claim 9, wherein the regasification equipment comprises:
at least one ethylene glycol heat exchanger;
a glycol pump;
a glycol tank; and
a LNG pump.

11. The MSRU of claim 10, wherein the secondary containment unit comprises an inlet line operatively coupled to the LNG storage tank and the second LNG storage tank for delivery of LNG by a tanker truck.

12. The MSRU of claim 10, wherein the secondary containment unit comprises a control room housing computer equipment to control the operation of the MSRU.

13. The MSRU of claim 12, wherein the computer equipment comprises an operator interface with a display.

14. A power generation application comprising the MSRU of claim 1.

15. A power generation application comprising the MSRU of claim 10.

16. A heating application comprising the MSRU of claim 1.

17. A heating application comprising the MSRU of claim 10.
